(19) United States
(12) Patent Application Publication
(10) Pub. No.: US 2016/0191922 A1
(43) Pub. Date: Jun. 30, 2016

(54) MIXED-LEVEL MULTI-CORE PARALLEL VIDEO DECODING SYSTEM

(71) Applicant: MEDIATEK INC., Hsin-Chu (TW)

(72) Inventors: Ping Chao, Taipei City (TW); Chia-Yun Cheng, Hsinchu County (TW); Chih-Ming Wang, Hsinchu County (TW); Yung-Chang Chang, New Taipei City (TW)

(21) Appl. No.: 14/979,546

(22) Filed: Dec. 28, 2015

Related U.S. Application Data
(60) Provisional application No. 62/096,922, filed on Dec. 26, 2014.

(51) Int. Cl. H04N 19/146; H04N 19/127; H04N 19/172

(52) U.S. Cl. CPC H04N 19/146; H04N 19/172; H04N 19/127

(57) ABSTRACT

A method, apparatus and computer readable medium storing a corresponding computer program for decoding a video bitstream based on multiple decoder cores are disclosed. In one embodiment of the present invention, the method arranges multiple decoder cores to decode one or more frames from a video bitstream using mixed level parallel decoding. The multiple decoder cores are arranged into groups of multiple decoder cores for parallel decoding one or more frames by using one group of multiple decoder cores for said one or more frames, wherein each group of multiple decoder cores comprises one or more decoder cores. The number of frames to be decoded in the mixed level parallel decoding or which frames to be decoded in the mixed level parallel decoding is adaptively determined.

### CROSS REFERENCE TO RELATED APPLICATIONS

The present invention claims priority to U.S. Provisional patent application, Ser. No. 62/096,922, filed on Dec. 26, 2014. The present invention is also related to U.S. patent application Ser. No. 14/259,144, filed on Apr. 22, 2014. The U.S. Provisional patent application and the U.S. patent application are hereby incorporated by reference in their entireties.

### BACKGROUND

The present invention relates to video decoding system. In particular, the present invention relates to video decoding using multiple decoder cores arranged for Inter-frame level and Intra-frame level parallel decoding to minimize computation time, to minimize bandwidth requirement, or both.

Compressed video has been widely used nowadays in various applications, such as video broadcasting, video streaming, and video storage. The video compression technologies used by newer video standards are becoming more sophisticated and require more processing power. On the other hand, the resolution of the underlying video is growing to match the resolution of high-resolution display devices and to meet the demand for higher quality. For example, compressed video in High-Definition (HD) is widely used today for television broadcasting and video streaming. Even UHD (Ultra High Definition) video is becoming a reality and various UHD-based products are available in the consumer market. The requirements of processing power for UHD contents increase rapidly with the spatial resolution. Processing power for higher resolution video can be a challenging issue for both hardware-based and software-based implementations. For example, an UHD frame may have a resolution of 3840×2160, which corresponds to 8,294,440 pixels per picture frame. If the video is captured at 60 frames per second, the UHD will generate nearly half billion pixels per second. For a color video source at YUV444 color format, there will be nearly 1.5 billion samples to process in each second. The data amount associated with the UHD video is enormous and poses a great challenge to real-time video decoder.

In order to fulfill the computational power requirement for high-definition, ultra-high resolution and/or more sophisticated coding standards, high speed processor and/or multiple processors have been used to perform real-time video decoding. For example, in the personal computer (PC) and consumer electronics environments, a multi-core Central Processing Unit (CPU) may be used to decode video bitstream. The multi-core system may be in a form of embedded system for cost saving and convenience. In a conventional multi-core decoder system, a control unit often configures the multiple cores (i.e., multiple video decoder kernels) to perform frame-level parallel video decoding. In order to coordinate memory access by the multiple video decoder kernels, a memory access control unit may be used between the multiple cores and the shared memory among the multiple cores.

FIG. 1A illustrates a block diagram of a general dual-core video decoder system for frame-level parallel video decoding. The dual-core video decoder system 100A includes a control unit 110A, decoder core 0 (120A-0), decoder core 1 (120A-1) and memory access control unit 130A. Control unit 110A may be configured to designate decoder core 0 (120A-0) to decode one frame and designate decoder core 1 (120A-1) to decode another frame in parallel. Since each decoder core has to access reference data stored in a storage device such as memory, memory access control unit 130A is connected to memory and is used to manage memory access by the two decoder cores. The decoder cores may be configured to decode a bitstream corresponding to one or more selected video coding formats, such as MPEG-2, H.264/AVC and the new high efficiency video coding (HEVC) coding standards.

FIG. 1B illustrates a block diagram of a general quad-core video decoder system for frame-level parallel video decoding. The quad-core video decoder system 100B includes a control unit 110B, decoder core 0 (120B-0) through decoder core 3 (120B-3) and memory access control unit 130B. Control unit 110B may be configured to designate decoder core 0 (120B-0) through decoder core 3 (120B-3) to decode different frames in parallel. Memory access control unit 130B is connected to memory and is used to manage memory access by the four decoder cores.

While any compressed video format can be used for the HD or UHD contents, it is more likely to use newer compression standards such as H.264/AVC or HEVC due to their higher compression efficiency. FIG. 2 illustrates an exemplary system block diagram for video decoder 200 to support HEVC video standard. High-Efficiency Video Coding (HEVC) is a new international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block. A CU may begin with a largest CU (LCU), which is also referred as coded tree unit (CTU) in HEVC and each CU can be recursively split into four smaller CUs until the predefined minimum size is reached. Once the splitting of CU hierarchical tree is done, each CU is further split into one or more prediction units (PUs) according to prediction type and PU partition. Each CU or the residual of each CU is divided into a tree of transform units (TUs) to apply two-dimensional (2D) transforms.

In FIG. 2, the input video bitstream is first processed by variable length decoder (VLD) 210 to perform variable-length decoding and syntax parsing. The parsed syntax may correspond to Inter/Intra residue signal (the upper output path from VLD 210) or motion information (the lower output path from VLD 210). The residue signal usually is transform coded. Accordingly, the coded residue signal is processed by inverse scan (IS) block 212, inverse quantization (IQ) block 214 and inverse transform (IT) block 216. The output from inverse transform (IT) block 216 corresponds to reconstructed residue signal. The reconstructed residue signal is added using an adder block 218 to Intra prediction from Intra prediction block 224 for an Intra-coded block or added to Inter prediction from motion compensation block 222 for an Inter-coded block. Inter/Intra selection block 226 selects Intra prediction or Inter prediction for reconstructing the video signal depending on whether the block is Inter or Intra coded. For motion compensation, the process will access one or more reference blocks stored in decoded picture buffer 230 and motion vector information determined by motion vector (MV) calculation block 220. In order to improve visual quality, in-loop filter 228 is used to process reconstructed video before it is stored in the decoded picture buffer 230. The in-loop filter includes deblocking filter (DF) and sample adaptive offset (SAO) in HEVC. The in-loop filter may use different filters for other coding standards.

Due to the high computational requirements to support real-time decoding for HD or UHD video, multi-core decoders have been used to improve the decoding speed. However, the structure of existing multi-core decoders is often restricted to frame-based parallel decoding, which can reduce memory bandwidth consumption with reference frame access reuse among two or more frames during decoding. However, Inter-frame level parallel decoding using multiple decoder cores may not be suitable for all types of frames. Accordingly, an Intra-frame based multi-core decoder has been disclosed in U.S. patent application Ser. No. 14/259,144, which uses macroblock row, slice, or tile level parallel decoding to achieve balanced decoding time for decoder kernels and to efficiently reduce computation time. However, the memory bandwidth efficiency may not be as good as the Inter-frame based multi-core decoder system. Accordingly, it is desirable to develop multi-core decoder system that can reduce computation time and memory bandwidth consumption simultaneously.

### SUMMARY

A method, apparatus and computer readable medium storing a corresponding computer program for decoding a video bitstream based on multiple decoder cores are disclosed. In one embodiment of the present invention, the method arranges multiple decoder cores to decode one or more frames from a video bitstream using mixed level parallel decoding. The multiple decoder cores are arranged into one or more groups of multiple decoder cores for mixed level parallel decoding one or more frames by using one group of multiple decoder cores for each of said one or more frames. Each group of multiple decoder cores may comprise one or more multiple decoder cores. The number of frames to be decoded in the mixed level parallel decoding or which frames to be decoded in the mixed level parallel decoding is adaptively determined.

According to one aspect of the present invention, mixed level parallel decoding for two or more frames versus single frame decoding for each of two or more frames is determined based on various factors. In one example, two or more frames are selected for mixed level parallel decoding if parallel decoding based on said two or more frames results in more efficient decoding time, less bandwidth consumption or both than single frame decoding for said two or more frames. In another example, two or more frame are selected for mixed level parallel decoding if there is no data dependency between said two or more frames. In yet another example, only one frame is selected to be decoded at a time if the frame has data dependency with all following frames, the frame has substantially different bitrate from following frames, or the frame has different resolution, slice type, tile number or slice number from following frames in a decoding order. In yet another example, two frames are selected for the mixed level parallel decoding if the two frames have no data dependency in between and the two frames achieve maximal memory bandwidth reduction. This situation may correspond to two frames having maximal overlapped reference list.

Another aspect of the present invention addresses smart scheduler for controlling the parallel decoder using multiple decoder cores. For example, two or more frames can be selected for mixed level parallel decoding according to data dependency determined based on pre-decoding information associated with whole or a portion of two or more frames. For example, frame X and frame (X+n) can be selected for the mixed level parallel decoding if pre-decoding information of frame (X+n) indicates that frame X through frame (X+n−1) are not in a reference list of frame (X+n), wherein frame X through frame (X+n) are in a decoding order, X is an integer and n is an integer greater than 1. In the case of n equal to 1, frame X and frame (X+1) are selected for the mixed level parallel decoding if pre-decoding information of frame (X+1) indicates that frame X is not in a reference list of frame (X+1).

For arranging the multiple decoder cores into one or more groups, each group of multiple decoder cores may consist of a same number of multiple decoder cores. Also, two groups of multiple decoder cores may consist of different numbers of multiple decoder cores.

In one embodiment, when only one frame is selected to be decoded at a time, the decoding is performed on the frame using at least two decoder cores in parallel. The parallel decoding may correspond to block level, block-row level, slice level or tile level parallel decoding. In another embodiment, when only one frame is selected to be decoded at a time, the decoding is performed using only one decoder core for each frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates an exemplary decoder system with dual decoder cores for parallel decoding.

FIG. 1B illustrates an exemplary decoder system with quad decoder cores for parallel decoding.

FIG. 2 illustrates an exemplary decoder system block diagram based on the HEVC (High Efficiency Video Coding) standard.

FIG. 3A illustrates an example of Inter-frame level parallel decoding using dual decoder cores.

FIG. 3B illustrates an example of Intra-frame level parallel decoding using dual decoder cores.

FIG. 4 illustrates an example of Inter-frame level parallel decoding and Intra-frame level parallel decoding using dual decoder cores according to an embodiment of the present invention.

FIG. 5 illustrates an example of mixed-level parallel decoding using three decoder cores according to an embodiment of the present invention.

FIG. 6 illustrates an example of data dependency issue associated with assigning two frames to two decoder cores in a conventional approach for inter-frame level parallel decoding.

FIG. 7 illustrates an example of assigning a non-reference frame and a following frame to multiple decoder cores for mixed level parallel decoding according to an embodiment of the present invention.

FIG. 8 illustrates an example of assigning multiple frames to multiple decoder cores for mixed level parallel decoding using pre-decoding information according to an embodiment of the present invention.

FIG. 9 illustrates an example of assigning Frame X and Frame (X+n) to multiple decoder cores for mixed level parallel decoding using pre-decoding information associated with Frame (X+n) according to an embodiment of the present invention.

FIG. 10 illustrates an example of assigning two frames with maximum overlap of reference list to multiple decoder cores for mixed level parallel decoding according to an embodiment of the present invention.

FIG. 11 illustrates an example of mixed level parallel decoding for one or more frames using dual decoder cores according to an embodiment of the present invention.

FIG. 12 illustrates another example of mixed level parallel decoding for one or more frames using dual decoder cores according to an embodiment of the present invention, where one decoding core is put into sleep mode or released for other tasks when both cores are assigned to a single frame.

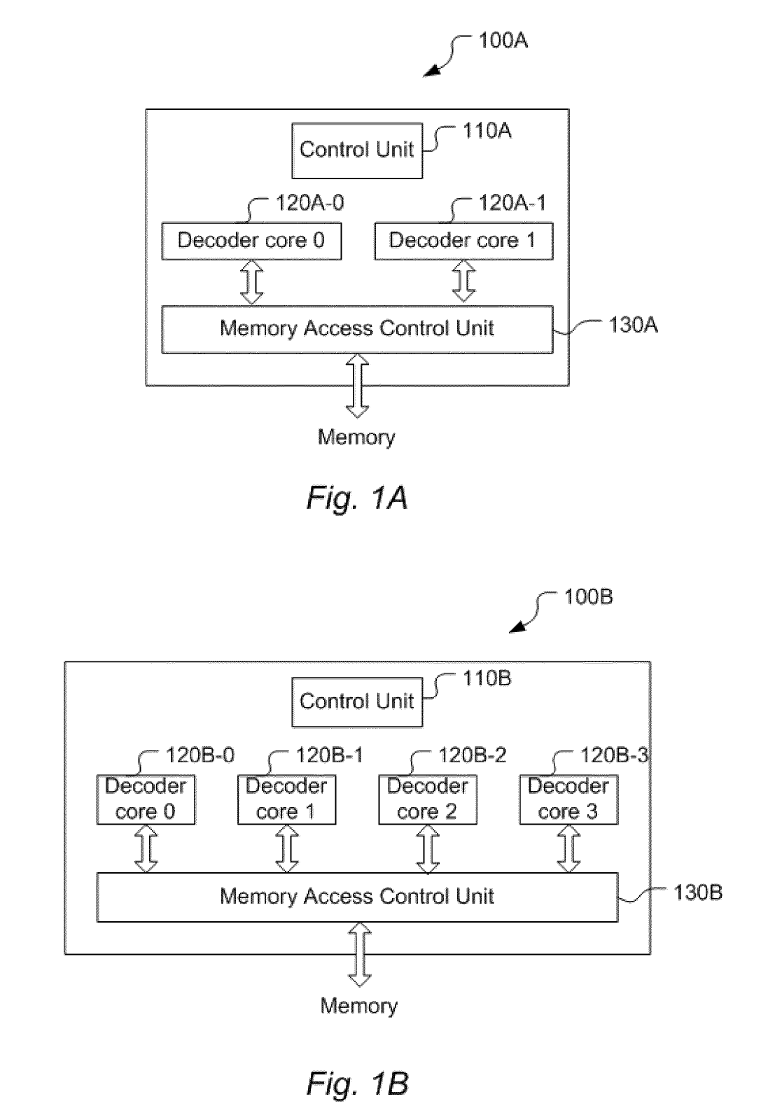

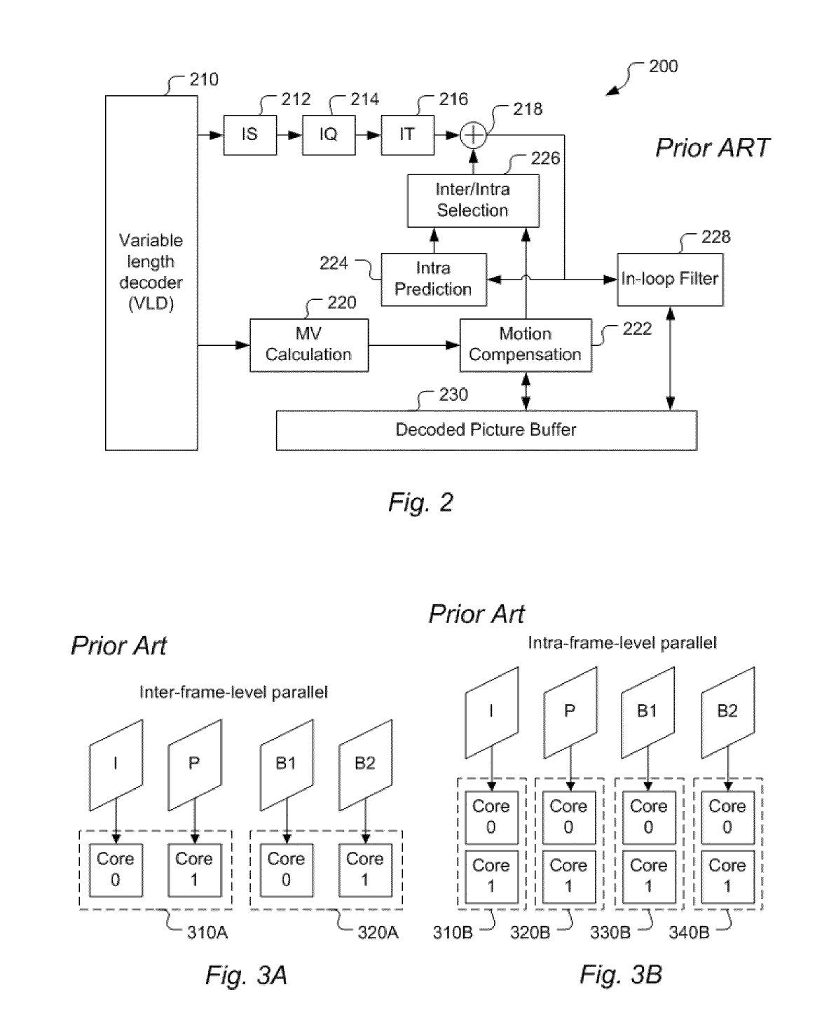

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention discloses multi-core decoder systems that can reduce computation time as well as memory bandwidth consumption simultaneously. According to one aspect of the present invention, the candidates of video frames are chosen and assigned to a level of parallel decoding mode to achieve improved performance in terms of reduced computation time and memory bandwidth consumption.

In order to achieve the goal of simultaneous computation time and memory bandwidth reduction, the present invention configures each decoder in the multi-core decoder system into an Inter-frame level parallel decoder, an Intra-frame level parallel decoder or both levels individually and dynamically. In other words, mixed level parallel decoding is to perform Inter-frame level parallel decoding, Intra-frame parallel decoding or both of them simultaneously. For example, the multi-core decoder system can be configured to an Intra-frame level parallel decoder to perform block level, block-row level, slice level or tile level parallel decoding. FIG. 3A illustrates an exemplary multi-core decoder configuration, where two decoder cores (310A, 320A) are configured to support Inter-frame level parallel decoding. The configuration in this example is intended for decoding four pictures coded in IBBP mode, where a leading picture is Intra coded; a picture that is 3 pictures away from the I-picture is predictive (P) coded using the I-picture as a reference picture; and the two pictures between the I-picture and the P-picture are bi-directional (B) predicted using I-picture and P-picture as reference pictures. As shown in FIG. 3A, the I-picture is decoded using decoder core-0 and the P-picture is decoded using decoder core-1. In this case, the dual cores (310A) are configured to decode I-picture and P-picture in parallel. Since the decoding of the P-picture relies on the reconstructed I-picture, the decoder core-1 has to wait till at least a portion of the I-picture is reconstructed before the decoder core-1 can start decoding the P-picture. After I-picture is reconstructed, the decoder core-0 can be assigned to decode one B-picture (B₁). After P-picture is reconstructed, the decoder core-1 can be assigned to decode another B-picture (B₂). In this case, the dual cores (320A) are configured to decode B₁-picture and B₂-picture in parallel. According to the present invention, the system may also configure the two decoder cores to perform Intra-frame decoding as shown in FIG. 3B. As shown in FIG. 3B, both decoder cores (310B-340B) are always configured to process a same frame in parallel. In other words, whether the picture being decoded is an I-picture, P-picture or B-picture, both decoder cores are always assigned to the same frame to perform Intra-frame level parallel decoding.

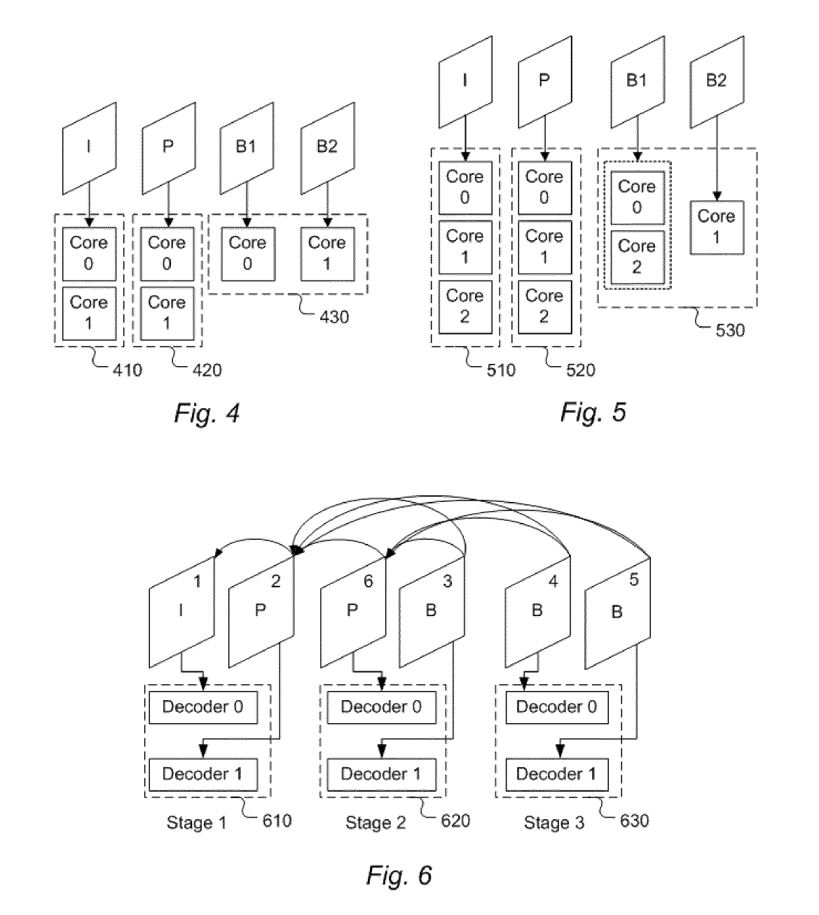

Furthermore, according to the present invention, the system may configure the multiple decoder cores for Intra-frame level parallel decoding for one or more frames and then switch to Inter-frame level parallel decoder for two or more frames. FIG. 4 illustrates an example according to one embodiment of the present invention, where two decoder cores are configured for single frame decoding (410, 420) for the I-picture and the P-picture. As mentioned before, due to data dependency between the I-picture and the P-picture, processing of the P-picture will have to wait for the processing of the I-picture. For the Inter-frame level parallel decoding, one decoder core may have to be idle during waiting. Therefore, Intra-frame level parallel decoding is more suited for the I-picture and the P-picture in this example. For the two B-pictures, the two decoder cores are configured for Inter-frame level parallel decoding (430). In this case, both B-pictures rely on the same reference pictures (i.e., I-picture and P-picture). The memory access efficiency is greatly improved.

In another embodiment of the present invention, multi-core groups can be arranged or configured for Inter-frame level parallel decoding and Intra-frame parallel decoding simultaneously. FIG. 5 illustrates an example according to this embodiment. In FIG. 5, three decoder cores are used. For the I-picture and the P-picture, all three decoder cores are assigned to each picture for Intra-frame level parallel decoding (510, 520). However, for the two B-pictures, the decoder core-0/2 group and decoded core-1 are configured for Inter-frame level parallel decoding and Intra-frame level parallel decoding at the same time (530). In the example shown in FIG. 5, decoder cores 0 and 2 are considered as a decoder core group. Similarly, decoder 1 can also be considered as a decoder group having only one decoder core. During decoding of the I-picture and the P-picture, the decoder core group (i.e., cores 0 and 2) and the decoder core 1 are configured for Intra-frame level parallel decoding for the I-picture as well as for the P-picture. However, during B1 and B2 decoding, the decoder core group (i.e., cores 0 and 2) and the decoder core 1 are configured for Inter-frame level and Intra-frame level parallel decoding simultaneously for B1-picture and B2-picture. While three decoder cores are used in FIG. 5, more decoder cores may be used for parallel decoding. Furthermore, these decoder cores can be grouped into two or more decoder core groups to support desired performance or flexibility.

For Inter-frame level parallel decoding, due to data dependency, the mapping between to-be-decoded frames and multiple decoder kernels has to be done carefully to maximize performance. FIG. 6 illustrates an example of six pictures (i.e., I, P, P, B, B and B) in decoding order. These six pictures may correspond to I(1), P(2), B(3), B(4), B(5) and P(6) in display order, where the number in parenthesis represents the picture in display order. Picture I(1) is Intra coded by itself without any data dependency on any other picture. Picture P(2) is uni-directional predictive using reconstructed I(1) picture as a reference picture. When I(1) and P(2) are assigned to decoder kernel 0 and decoder kernel 1 respectively for parallel decoding (610), there will be data dependency issue. Similarly, when P(6) and B(3) are assigned to decoder kernel 0 and decoder kernel 1 respectively for parallel decoding in the second stage (620), the data dependency issue arises again. The last to-be-decoded pictures B(4) and B(5) are assigned to decoder kernel 0 and decoder kernel 1 respectively for parallel decoding in the third stage (630). Since both P(2) and P(6) are available at this time, there will be no data dependency issue for decoding B(4) and B(5) in parallel.

In order to overcome the data dependency issue as illustrated above, one aspect of the present invention addresses smart scheduler for multiple decoder kernels. In particular, the smart scheduler detects which frames can be decoded in parallel without data dependency; detects which combination of frames for mixed level parallel decoding that can provide maximized memory bandwidth efficiency; decides when to perform Intra/Intra frame level parallel decoding; and decides when to perform Inter and Intra frame level parallel decoding at the same time.

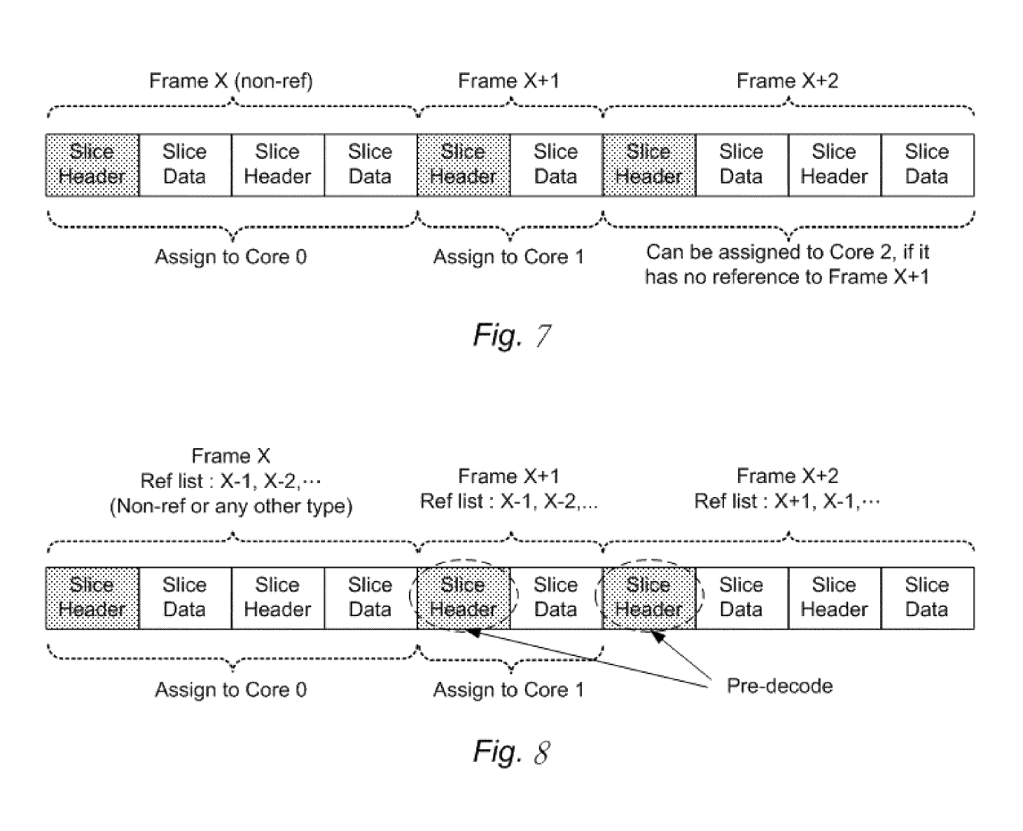

For detecting which frames can be decoded in parallel without data dependency, one embodiment according to the present invention checks for non-reference frames. Non-reference frames can be determined by detecting NAL (network adaptation layer) type, slice header or any other information regarding whether the frame will not be referenced by any other frame. The non-reference pictures can be decoded in parallel. Also a non-reference frame and be decoded in parallel with any following frame. Let Frame 0, Frame1, Frame 2, . . . denote frames in decoding order. A non-reference picture (Frame X) can be decoded in parallel with any following frame (Frame X+n), where X and n are integers and n>0. FIG. 7 illustrates an example of using non-reference pictures for mixed level parallel decoding. As shown in FIG. 7, the bitstream includes three frames (i.e., Frame X, Frame (X+1) and Frame (X+2) in decoding order) and each frame comprises one or more slices. Frame X is determined to be a non-reference picture that is not referenced by any other picture. Therefore, any following picture in decoding order can be decoded in parallel with Frame X. Accordingly, the following picture, Frame (X+1) can be decoded in parallel with non-referenced picture Frame X by assigning Frame X to decoder core 0 and Frame (X+1) to decoder core 1. If the further next picture Frame (X+2) does not reference to with Frame X and Frame (X+1), Frame (X+2) can be assign to decoder core 2.

In order to determine data dependency, an embodiment of the present invention performs picture pre-decoding. Pre-decoding can be performed for a whole frame or part of a frame (e.g. Frame X+n) to obtain its reference list. Based on the reference list, the system can check if there is any previous frame (i.e., Frame X) of the selected frame (i.e., Frame X+n) in the list and decide whether Frame X and Frame X+n can be decoded in parallel. FIG. 8 illustrates an example of pre-decoding according to an embodiment of the present invention, where n is equal to 1. Pre-decoding is applied to Frame X+n (i.e., Frame (X+1)). In this example, the slice headers of Frame (X+1) are pre-decoded and checked to determine whether any slice uses Frame X as reference picture. If not, Frame (X+1) and Frame X can be assigned to two different decoder kernels for mixed level parallel decoding. If the pre-decoded results indicate that Frame (X+1) depends on Frame X, the two frames should not be assigned to two decoder kernels for mixed level parallel decoding. The syntax structure illustrated in FIG. 8 is intended to show that the pre-decoding can help improve computational efficiency of mixed level parallel decoding according to an embodiment of the present invention. The particular syntax structure shall not be construed as limitations of the present invention. For example, instead of slice data structure, a frame may use coding tree unit (CTU) data structure or tile data structure with associated headers and the associated headers can be pre-decoded to determine data dependency.

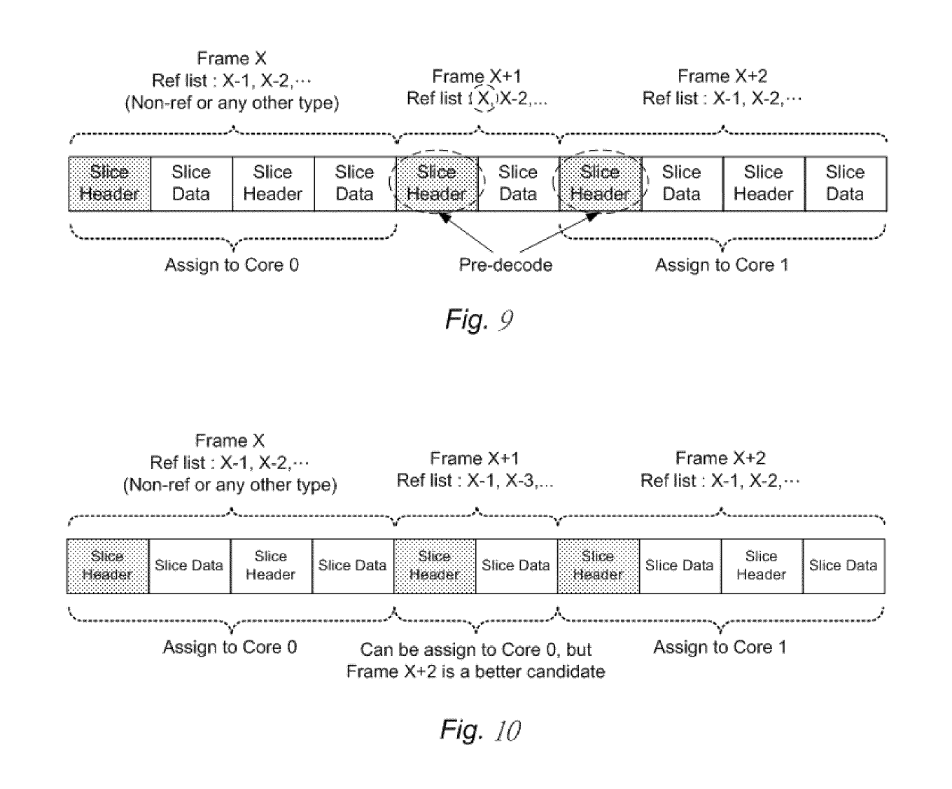

For the case of n>1, more dependency checking other than Frame X will be required to determine whether Frame (X+n) and Frame X can be assigned to two decoder kernels for mixed level parallel decoding. In addition to checking dependency on Frame X, an embodiment of the present invention will further check pre-decoded information to determine whether the reference list of Frame X+n includes any one reference data from Frame (X) to Frame (X+n−1). If not, Frame (X+n) and Frame X can be assigned to two different decoder kernels for mixed level parallel decoding. If the pre-decoded results indicate that Frame (X+n) depends on Frame X or any frame from Frame (X) to Frame (X+n−1), then Frame (X+n) and Frame X should not be assigned to two decoder kernels for mixed level parallel decoding. FIG. 9 illustrates an example of pre-decoded information checking for n equal to 2. For Frame (X+1), the pre-decoded information indicates that Frame X is in its reference list. Therefore Frame (X+1) and Frame X are not suited for mixed level parallel decoding. The system according to an embodiment of the present invention will check pre-decoding information associated with Frame (X+1). Since neither Frame (X+1) nor Frame X is in the reference list of Frame (X+2), Frame (X+2) and Frame X are assigned to decoder core 0 and decoder core 1 respectively for mixed level parallel decoding.

In yet another embodiment of the present invention, the system detects which combination of frames for mixed level parallel decoding can provide maximum memory bandwidth efficiency (i.e., minimum bandwidth consumption). In some cases, there may be multiple frame candidates that can be decoded in parallel. Different combinations of candidates for mixed level parallel decoding may cause different bandwidth consumptions. An embodiment of the present invention will select the candidates with the maximum overlap of reference list in order to achieve the optimized bandwidth reduction from mixed level parallel decoding. Since these frames to be decoded using mixed level parallel decoding have the maximum overlap of reference list, the overlapped reference pictures can be reused for decoding these parallel decoded frames. Accordingly, better bandwidth efficiency is achieved. FIG. 10 illustrates an example of pre-decoded information checking for n equal to 2. In this example, both Frame X/Frame (X+1) and Frame X/Frame (X+2) can be assigned to two decoder kernels for mixed level parallel decoding. However, the reference lists for Frame X, Frame (X+1) and Frame (X+2) include {(X−1), (X−2)}, {(X−1), (X−3)} and {(X−1), (X−2)} respectively. Therefore, mixed level parallel decoding for Frame X and Frame (X+2) has the maximum number of overlapped reference frames in the reference lists. Accordingly, Frame X and Frame (X+2) are assigned to decoder kernels for mixed level parallel decoding in order to achieve the optimal bandwidth efficiency. While FIG. 10 illustrates an example for two decoder cores, the present invention is applicable to more than two decoder cores. Also, the multiple decoder cores may be configured into groups of multiple decoder cores to support mixed level parallel decoding.

In an alternative approach, the system may stall and switch job for a core to achieve pre-decoding. For example, a system may always perform Inter-frame level parallel decoding for every two frames. After the slice header is decoded, data dependency information is revealed and may disadvantage Inter-frame level parallel decoding. The system can stall the decoding job for the following frame and switch the stalled core to decode the first frame with the other core together for Intra-frame level parallel decoding to achieve adaptive determination of Inter/Intra frame level parallel decoding.

In an alternative approach, the system may pre-process the video bitstream using a tool and insert one or more frame-dependency Network Adaptation Layer (NAL) units associated with the video bitstream to indicate frame dependency. In yet another alternative approach, the system may use one or more frame-dependency syntax elements to indicate frame dependency. The frame dependency syntax element may be inserted in the sequence level of the video bitstream.

In yet another embodiment of the present invention, the system performs mixed level parallel decoding, where the number of frames to be decoded in parallel or which frames to be decoded are adaptively determined. When frames have no data dependency or/and have maximum reference list overlap, the frames are assigned to Inter-frame level parallel decoding in order to save memory bandwidth. On the other hand, all decoder-kernels will be assigned to a frame for Intra-frame level parallel decoding in order to achieve better computational efficiency. In other words, the decoder kernels are configured for Intra-frame level parallel decoding of the frame in order to maximizing decoding time reduction. The system may predict cases that could cause lower efficiency for mixed level parallel decoding. In such cases, the system will switch to Intra-frame level parallel decoding that may have better computational efficiency. For example, if a frame has data dependency on the following frames, it would be computationally inefficient if the frame and the following frame are configured for Inter-frame level parallel decoding. Therefore, the frame with dependency on following frames will be processed by Intra-frame level parallel decoding according to an embodiment of the present invention. In another case, if a frame has significantly different bitrate, the frame will be configured for Intra-frame level parallel decoding. The bitrate associated with a frame is related to the coding complexity. For example, for a same coding type (e.g. P-picture), a very high bitrate implies very higher computational complexity since there is likely more coded symbols to parse and to decode. If such frame is Inter-frame level parallel decoded along with another typical frame, the decoder kernel for the other frame may have finish decoding long before for the high bitrate frame. Therefore, the Inter-frame level parallel decoding would be inefficient due to the unbalanced computation times for the two frames. Accordingly, Intra-frame level parallel decoding should be used for this frame with very different bitrate.

In yet another case, if a frame has different resolutions, slice types, or tile or slice numbers, the frame will be configured for Intra-frame level parallel decoding. The picture resolution is directly related to decoding time. In some video standard, such as VP9, allows the coding frames to change resolution over the sequence of frames. Such resolution change will affect decoding time. For example, a picture having a quarter-resolution is expected to consume a quarter of typical decoding time. If such frame is decoded with a regular-resolution picture using Inter-frame level parallel decoding, the decoding of such frame would have been completed while a regular-resolution picture may take much longer time to finish decoding. The unbalanced decoding time will lower the coding efficiency for Inter-frame level parallel decoding. For different slice types (e.g. I-slice vs B-slice), the decoding time will be very different. For the I-slice, there is no need for motion compensation. On the other hand, motion compensation may be computationally intensive, particularly for the B-slice. Two frames with different slice types will cause unbalanced computation times and will cause lower efficiency for Inter-frame level parallel decoding.

Furthermore, some modern video encoder tools allow deciding slice layout adaptively by detecting the scene in a picture to enhance coding efficiency. Two frames with very different slice number may imply that there is scene change between them. In this case, there may not be much overlap of the reference windows between the two frames. For frames with different tile layout will induce different scan order for the block-based decoding (raster scan inside each tile then raster scan over tiles in HEVC), which may degrade the bandwidth reduction efficiency. Since the two decoder cores may process two blocks far from each other respectively, it will cause reference frame data sharing inefficient. Accordingly, different tile or slice numbers may be an indication of lower efficiency for Inter-frame level parallel decoding since.

FIG. 11 illustrates an example of mixed level parallel decoding according to the above embodiment. For the I-picture and the P-picture, the slices in these two frames are likely in different slice types. The decoding complexity for the I-picture is likely lower than the P-picture. Due to the unbalanced decoding time, the system will favor the Intra-frame level parallel decoding by arranging decoder cores 0 and 1 for Intra-frame level parallel decoding (1110, 1120) to achieve better decoding time balance according to an embodiment of the present invention. Therefore, Intra-frame level parallel decoding will be used for the I-picture and the P-picture respectively. For the B1 and B2 picture, both pictures are independent of each other (i.e., no data dependency in between). Furthermore, both pictures use the I-picture and the P-picture as reference pictures. The two pictures have maximum overlapped reference list. Accordingly, the two pictures are decoded using Inter-frame level parallel decoding by arranging decoder cores 0 and 1 for Inter-frame level parallel decoding (1130).

In yet another embodiment of the present invention, the system performs Inter-frame level parallel decoding and Intra-frame parallel decoding simultaneously. The mixed-level parallel decoding process comprises two steps. In the first step, the system selects how many frames or which to be decoded in parallel and two or more frames are selected in this case. In the second step, the system assigns a group of decoder-kernels with Intra-frame level parallel decoding mode to one of the frames. For the Intra-frame level parallel decoding mode, the system may assign a group of kernels with identical number of kernels to each selected frame. The system may also assign a group of kernels with a different number of kernels to each selected frame. The number of kernel can be determined by predicting if the frame requires more computational resources compared to other selected frames. When the system forms groups of decoder cores, each group may have the same number of decoder cores. The groups may also have different numbers of decoder cores as shown in FIG. 5.

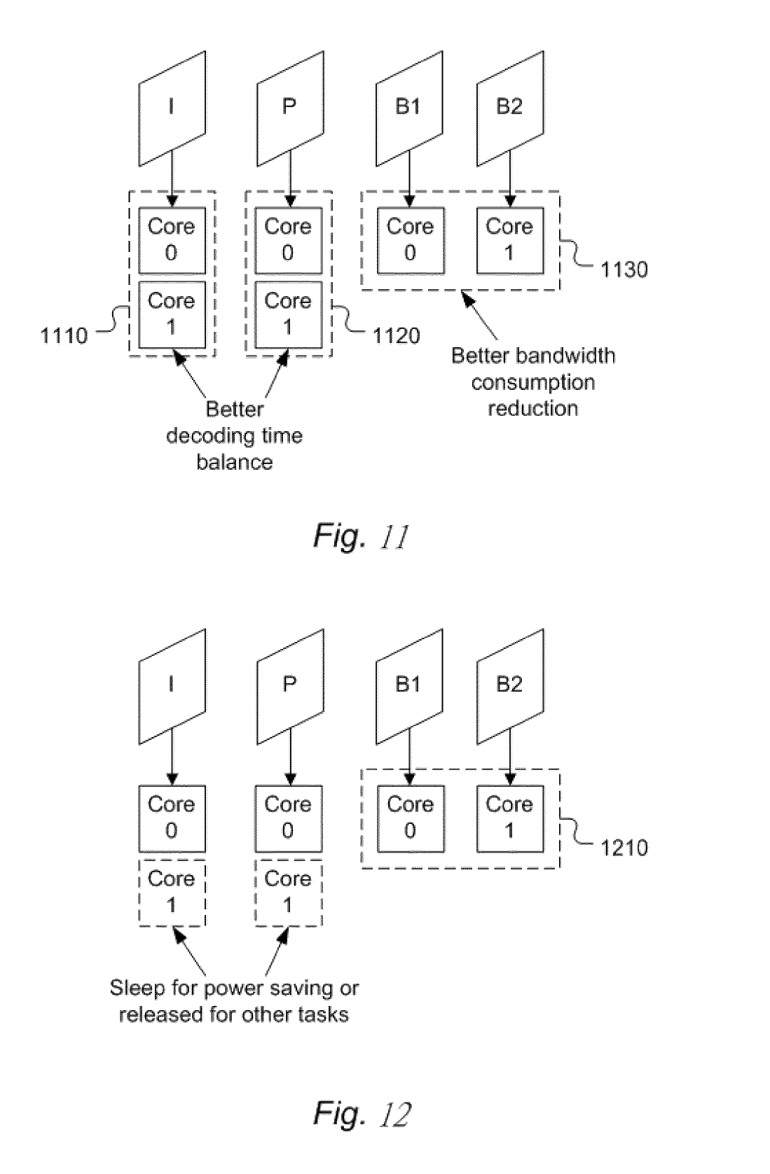

In the above disclosure, when Inter-frame parallel decoding is not selected, the Intra-frame parallel decoding is used based on multiple decoder cores. Nevertheless, for the non-Inter-frame parallel decoded frames, they don't have to be Intra-frame decoded using multiple decoder cores in parallel. For example, for the two non-Inter-frame parallel decoded I-picture and P-picture, a single core (e.g. core 0) can be used, while other decoder core(s) can be set to sleep/idle to conserve power and assigned to perform other tasks as shown in FIG. 12. In FIG. 12, parallel decoding is only applied to Inter-frame parallel decoded frames (i.e., B1 and B2 pictures) using decoder core 0 and decoder core 1 (1210). For convenience, non-Inter-frame parallel decoded pictures are referred as Intra-frame decoded pictures using only one decoder core (e.g. FIG. 12) or at least two decoder cores (e.g. FIG. 11).

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The software code may be configured using software formats such as Java, C++, XML (extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention. The software code may be executed on different types of devices, such as laptop or desktop computers, hand held devices with processors or processing logic, and also possibly computer servers or other devices that utilize the invention. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for decoding a video bitstream using multiple decoder cores, the method comprising:
arranging multiple decoder cores to decode one or more frames from a video bitstream using mixed level parallel decoding, wherein:
the multiple decoder cores are arranged into one or more groups of multiple decoder cores for parallel decoding one or more frames, wherein each group of multiple decoder cores comprises one or more decoder cores for decoding one frame; and
wherein number of frames to be decoded in the mixed level parallel decoding or which frames to be decoded in the mixed level parallel decoding is adaptively determined.

2. The method of claim 1, wherein two or more frames are selected for mixed level parallel decoding if mixed level parallel decoding for said two or more frames results in more efficient decoding time, less bandwidth consumption or both than single frame decoding for each of said two or more frames.

3. The method of claim 1, wherein two or more frames are selected for mixed level parallel decoding if there is no data dependency between said two or more frames.

4. The method of claim 1, wherein only one frame is selected to be decoded at a time if said one frame has data dependency with all following frames in a decoding order.

5. The method of claim 1, wherein only one frame is selected to be decoded at a time if said one frame has substantially different bitrate from following frames in a decoding order.

6. The method of claim 1, wherein only one frame is selected to be decoded at a time if said one frame has different resolution, slice type, tile number or slice number from following frames in a decoding order.

7. The method of claim 1, wherein number of frames for mixed level parallel decoding or which frames to be decoded in mixed level parallel decoding is adaptively determined according to one or more frame-dependency syntax elements signaled in the video bitstream or one or more frame-dependency Network Adaptation Layer (NAL) units associated with the video bitstream.

8. The method of claim 1, wherein two or more frames selected for mixed level parallel decoding comprise one non-reference frame and one following frame, wherein said one non-reference frame is not referenced by any other frame.

9. The method of claim 1, wherein two or more frames selected for mixed level parallel decoding are selected according to data dependency determined based on pre-decoding information associated with whole or a portion of said two or more frames.

10. The method of claim 9, wherein frame X and frame (X+n) are selected for mixed level parallel decoding if pre-decoding information of frame (X+n) indicates that frame X through frame (X+n−1) are not in a reference list of frame (X+n), wherein frame X through frame (X+n) are in a decoding order, X is an integer and n is an integer greater than 1.

11. The method of claim 9, wherein frame X and frame (X+1) are selected for mixed level parallel decoding if pre-decoding information of frame (X+1) indicates that frame X is not in a reference list of frame (X+1), wherein frame X and frame (X+1) are in a decoding order and X is an integer.

12. The method of claim 1, wherein two or more frames are selected for mixed level parallel decoding if said two or more frames have no data dependency in between and said two or more frames achieve maximal memory bandwidth reduction.

13. The method of claim 12, wherein said two or more frames have maximal overlapped reference list.

14. The method of claim 1, wherein each group of multiple decoder cores consists of a same number of multiple decoder cores.

15. The method of claim 1, wherein at least two groups of multiple decoder cores consist of different numbers of multiple decoder cores.

16. The method of claim 1, wherein one single frame is selected for parallel decoding using at least two decoder cores in parallel.

17. The method of claim 16, wherein the single frame parallel decoding corresponds to block level, block-row level, slice level or tile level parallel decoding.

18. A multi-core decoder system, comprising:
multiple decoder cores;
a memory control unit coupled to the multiple decoder cores and a storage device for storing decoded pictures and required information for decoding; and
a control unit arranged to decode one or more frames from a video bitstream using mixed level parallel decoding, wherein:
the multiple decoder cores are arranged into one or more groups of multiple decoder cores for parallel decoding one or more frames, wherein each group of multiple decoder cores comprises one or more decoder cores for decoding one frame; and
wherein number of frames to be decoded in the mixed level parallel decoding or which frames to be decoded in the mixed level parallel decoding is adaptively determined.

19. The multi-core decoder system of claim 18, wherein each group of multiple decoder cores consists of a same number of multiple decoder cores.

20. The multi-core decoder system of claim 18, wherein at least two groups of multiple decoder cores consist of different numbers of multiple decoder cores.

21. A computer readable medium storing a computer program for decoding a video bitstream using multiple decoder cores, the computer program comprising sets of instructions for:
arranging multiple decoder cores to decode one or more frames from a video bitstream using mixed level parallel decoding, wherein:
the multiple decoder cores are arranged into one or more groups of multiple decoder cores for parallel decoding one or more frames, wherein each group of multiple decoder cores comprises one or more decoder cores for decoding one frame; and
wherein number of frames to be decoded in the mixed level parallel decoding or which frames to be decoded in the mixed level parallel decoding is adaptively determined.
